(19) United States
(12) Patent Application Publication
(10) Pub. No.: US 2017/0134418 A1
(43) Pub. Date: May 11, 2017

(54) SYSTEM AND METHOD FOR A UNIFORM MEASURE AND ASSESSEMENT OF AN INSTITUTION'S AGGREGATE CYBER SECURITY RISK AND OF THE INSTITUTION'S CYBERSECURITY CONFIDENCE INDEX.

(71) Applicants: Daniel Minoli, Red Bank, NJ (US); Benedict Occhiogrosso, Perrineville, NJ (US); Emmanuel Coffy, Morganville, NJ (US)

(72) Inventors: Daniel Minoli, Red Bank, NJ (US); Benedict Occhiogrosso, Perrineville, NJ (US); Emmanuel Coffy, Morganville, NJ (US)

(21) Appl. No.: 15/296,005

(22) Filed: Oct. 17, 2016

Related U.S. Application Data
(60) Provisional application No. 62/284,983, filed on Oct. 16, 2015.

(51) Int. Cl. H04L 29/06

(52) U.S. Cl. CPC H04L 63/1433

(57) ABSTRACT

A system and method for a uniform measure and assessment of an institution's aggregate cyber security risk and of the institution's cybersecurity confidence index are provided. Moreover, the system and method enable a user to simulate and/or test the different vectors associated with computing a one-dimensional cybersecurity score.

This application claims the benefit to U.S. Provisional Application No. 62/284,983, filed on Oct. 16, 2015, which application is incorporated herein by reference as if set forth in its entirety.

### FIELD OF THE INVENTION

The present invention relates generally to the field of Information Technology (IT) and more particularly to system and method for establishing a common and uniform measure of aggregate cybersecurity risk.

### BACKGROUND OF THE INVENTION

Information Technology (IT) related cybersecurity risks have become a daily occurrence in modern business and personal transactions. The multitude of institutions and individuals that utilize the Internet implement different environments, have varying IT/connectivity goals and technical architectures, deployed incompatible technologies that communicate via a myriad of transmission channels, and as a result are subject to different cyber threats. It's been reported that while cyber threat is one of the fastest growing risks for companies worldwide, companies are only protecting 12% of soft or Intellectual Property (IP) assets as compared to 15% of tangible assets. Furthermore, over half of companies surveyed believe that its exposure to cyber risk will increase over the next two years.

### SUMMARY OF THE INVENTION

Various embodiments provide a system and method for uniform measure and assessment of an institution's aggregate a cyber security risk and of the institution's cybersecurity confidence index. Moreover, the present embodiments enable a user to simulate and/or test the different vectors associated with computing a one-dimensional cybersecurity score.

In one embodiment, a computer-implemented method is provided. The method comprises the steps of determining a skill level necessary to compromise the integrity of technical assets associated with security characteristics of a computer system;
(a) generating a map of data sets associated with the corresponding technical assets;
(b) identifying the characteristics of the data sets and availability of data associated with respective technical assets;
(c) determining a state of breach associated with a security event; and
(e) computing a one-dimensional cybersecurity score,

wherein the technical assets comprise information associated with the computer system.

Another embodiment provides a system, which includes a computing architecture having an input data interface engine communicatively coupled to a data analytics engine, a score engine, a central processing engine, one or more databases, said computing architecture configured to determine a common and uniform measure of aggregate cybersecurity risk; and a non-transitory computer readable medium having stored thereon instructions that, upon execution by the central processing engine, cause the central processing engine to execute one or more applications associated with defining a one-dimensional cybersecurity score thereby enabling the exchange of a plurality of data points for use in computing the one-dimensional cybersecurity score and updating the one or more corresponding applications, wherein the one-dimensional cybersecurity score is used to measure the robustness of a computer system architecture to security threats and breaches.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a system benefiting from embodiments of the present invention;

FIG. 2 depicts a high-level block diagram of a computing architecture benefiting from embodiments of the present invention;

FIG. 3 depicts an exemplary computing device suitable for use in the system depicted in FIG. 2;

FIG. 4 depicts an exemplary user screen interface suitable for use in the system depicted in FIG. 2;

FIG. 5 depicts an exemplary user screen interface suitable for use in the system depicted in FIG. 2; and

FIG. 6 depicts a Flow Chart of a process for implementing the algorithm according to an embodiment of the invention.

To facilitate understanding, identical reference numerals have been used to designate elements having substantially the same or similar structure and/or substantially the same or similar function.

### DETAILED DESCRIPTION OF THE INVENTION

Various embodiments provide a system and method for a uniform measure and assessment of an institution's aggregate cyber security risk and of the institution's cybersecurity confidence index. This uniform measure of an institution's aggregate cyber security risk provides a reference to compare different institutions, for example under audit, risk assessment, risk tolerance and risk mitigation scenarios. This uniform objective measure can be viewed as a Key Performance Indicator (KPI) value. Before- and after-assessments can be made when remedial strategies are undertaken or need to be compared. It is difficult to make comparisons based on vector values in n-th space, because the issue is multidimensional. Similar multidimensionality issues exists in other disciplines, for example in risk assessment for the financial dependability of a consumer—to address such needs the one-dimensional FICO® score has been introduced and is routinely employed.

There has been an explosive growth in the number of IT security breaches in the past few years as well as a large body of publications on the topic of security. Many processes have been advanced to enable enterprises to evaluate their e-security practices, apply best practices, apply continuous improvement, and acquire and deploy e-security services. However, there is a need for a uniform method of attaching a single-valued metric (a scalar) that captures in a rather simple way the complexity of the security situation as articulated above.

This disclosure describes an objective method and an ensuing one-dimensional cybersecurity score, called “MESERI” (MEasure of SEcurity Risk), which is intended to provide a uniform, cross-entity comparative measure of “complexity of the enterprise architecture robustness to security threats and breaches,” architectures and/or security strategies, enhancement thereof. Companies devote a lot of attention and resources to preventing the improper outflow of sensitive data that can happen from the inadvertent or deliberate actions of insiders, and to the insertion of malware that can lead to the exfiltration of data by cyber attackers. They have also learned to anticipate that attackers will penetrate their perimeter defenses, as exemplified by the Advanced Persistent Threat (APT), in which cyber criminals get inside their targets' network and spend weeks or months learning about their cybersecurity defenses and devising ways to mask their theft of data. Companies are therefore paying increased attention to the nuts and bolts of breach detection as the essential prelude to response and cure.

Three broad categories of breaches have been identified namely, human errors, System glitches and Malicious or criminal attacks. It is widely accepted that human errors cause most breaches, although they tend to be far less expensive than breaches caused by malicious and criminal attacks. Some breaches can clearly be attributed to the direct result of people's mistakes. These errors include for example, the misdelivery of sensitive information to the wrong person by email or fax; mistakenly making information publicly available on a web server or website; losing or inadequately disposing of data, including paper records; losing an unencrypted laptop, cellphone or storage device such as a USB key. The limits of human error can be hard to fix. For example, the loss of documents or of unencrypted laptops or devices may never lead to the actual theft or publication of sensitive data. Those losses can trigger breach response requirements under applicable laws, which are often triggered by the “failure to protect,” if there is a reasonable chance that someone will see the sensitive information. It can be harder to attribute causes when information is stolen rather than lost. For example, a device or system whose password is left at the default and easily determined value has elements of both human error (negligence) and a system glitch (improperly allowing access)—and it certainly makes a malicious attack easier. In some instances, contractors have access to a company's network through apparently easily stolen credentials, and the network may not have an adequate firewall blocking access to sensitive payment card data. Most cyber risk management programs consider only simple mistakes and omissions that directly compromise sensitive data as falling within the domain of human error breaches. Breaches directly caused by an intervening theft, even when the theft is made easier by policies and procedures that establish lax access controls and have other design or policing shortcomings, are generally treated as having been caused by a criminal attack.

A company may reduce and mitigate breaches resulting directly from simple human error primarily through a combination of data handling policies, access control and training. When the human error does not itself directly cause the exposure of sensitive data, but instead creates conditions that make theft or hacking easier, then dealing with the error requires deeper levels of cyber risk management that also involve the technology-focused efforts to thwart hackers and thieves and to minimize the unauthorized outflow of data or compromise of the network.

A system glitch on the other hand is a sudden, unexpected and usually temporary malfunction in a computer system or network. System glitches include software failures that create pathways for data to escape, be corrupted or destroyed, problems in applying software or firmware patches and updates, inadvertent data dumps, programming errors in the transfer of data, identity or authentication failures (wrongful access) and/or data recovery failures. System glitches are primarily technological, but other contributing causes such as shortfalls in funding (i.e., outdated software/hardware that are prone to crashing, insufficient staffing to perform the monitoring, measurement and review necessary for the continuous smooth functioning of systems and networks) as well as policies and procedures (the scheduling and responsibilities for the ongoing activities needed to maintain complex systems) can all lead to system glitches.

Finally, hackers and thieves are constantly devising new ways to overcome security defenses. Remediations to such breaches are only temporary. Malicious attacks cause fewer breaches than simple human error, but they are much more costly to the affected organization. The list of hacks and attacks that people use is long and growing. For example, physical theft or loss, misuse of privileges by rogue employee or other insiders, usually to exploit confidential information for financial or personal gain; attacks on web applications through exploitable weaknesses in coding or through theft of user credentials, phishing and other social engineering attacks; sending out legitimate-looking email or other inducements so users willingly provide financial or other personal information; pharming, or installing malicious software that misdirects unsuspecting users to fraudulent websites, where they are induced to provide log-in or other sensitive information that can be later exploited; Dedicated Denial of Service (DDoS) attacks designed to block the availability of networks and systems; cyber extortion by hackers demanding ransom (Ransomeware); Government and competitor cyber espionage; point-of-sale intrusions, remote (offsite) attacks against the places retail transactions are conducted through card-present purchases; payment card skimmers, a skimming device is implanted in a device that reads magnetic stripe data from a payment card. Examples include ATMs, gas pumps, and POS (Point of Sale) terminals, viruses, worms and Trojan Horses.

As defined in the industry, an enterprise can be a firm, an institution, an organization, a government agency, or even a division or subgroup of an entity or firm.

The illustrative system and method embodiments described herein are not meant to be limiting. It may be readily understood that certain aspects of the disclosed system and method can be arranged and combined in a variety of different configurations, all of which are contemplated herein.

Generally speaking, any computing device such as a cellular telephone or smart phone or any computing device having similar functionality may implement the various embodiments described herein. In various embodiments, any Internet enabled device such as personal digital assistant (PDA), laptop, desktop, electronic book, tablets and the like capable of accessing the Internet may implement the various embodiments described herein. While computing devices are generally discussed within the context of the description, the use of any device having similar functionality is considered to be within the scope of the present embodiments.

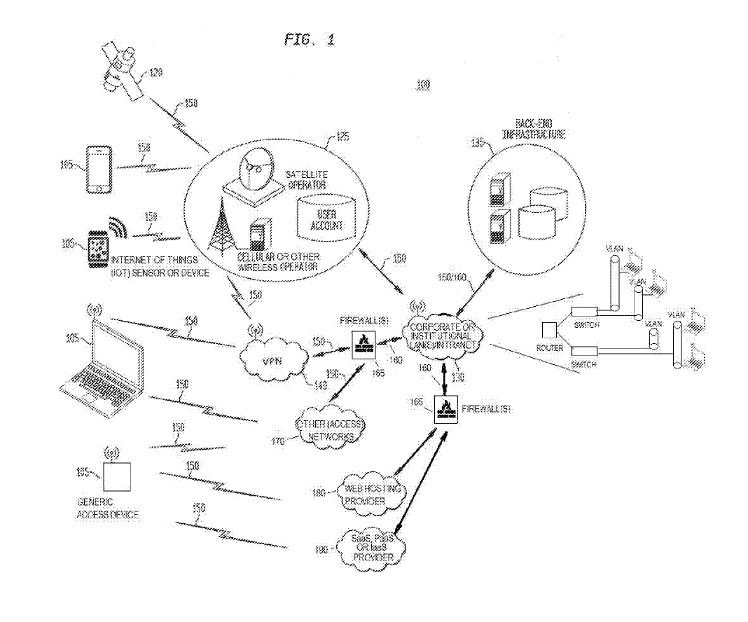

Referring now to the figures, FIG. 1 is a simplified block diagram of a system 100, according to an exemplary embodiment herein described.

In one embodiment, the user interacts with networks 120, 125, 135, 130, 140, 170, 180, 190 via link 150/160. In one embodiment, link 150 extends over great distance and is a cable, satellite or fiber optic link, a combination of such links or any other suitable communications path. In various embodiments, link 150 extends over a short distance. In one embodiment, link 150 is a network connection between geographically distributed systems, including network connection over the Internet. In other embodiments, link 150 is wireless.

In various embodiments, device 105 is a smart phone, cellular telephone, personal digital assistant (PDA), wireless hotspot or any internet-enabled device including a desktop computer, laptop computer, tablet computer, IoT (Internet of Things) sensor, IoMT (Internet of Medical Things) sensor) and the like capable of accessing the Internet may be used for device 105.

In various embodiments, Satellite 120 is a geo-synchronous satellite system such as global positioning system (GPS). In one embodiment, satellite 120 is low earth orbit satellite system. In other embodiments, the use of any system having similar functionality is considered to be within the scope of the present embodiments.

In various embodiments, Cellular system 125 is a wireless infrastructure supporting cellular network functionality. In one embodiment, cellular system 125 is a small area wireless system. In other embodiments, cellular system 125 is a wide area wireless system. In other embodiments, cellular system 125 is a Wi-Fi system. In various embodiments, Cellular system 125 supports mobile services within an LTE network or portions thereof, those skilled in the art and informed by the teachings herein will realize that the various embodiments are also applicable to wireless resources associated with other types of wireless networks (e.g., 4G networks, 3G networks, 2G networks, WiMAX, etc.), wireline networks or combinations of wireless and wireline networks. Thus, the network elements, links, connectors, sites and other objects representing mobile services may identify network elements associated with other types of wireless and wireline networks. In other embodiments, the use of any wireless system having similar functionality is considered to be within the scope of the present embodiments.

In various embodiments, network 130 is an access network. In one embodiment, network 140 is a virtual private network (VPN). In other embodiments, network 130 is any network having similar functionality and as such is considered to be within the scope of the present embodiments.

Backend infrastructure 135 generally refers to infrastructure associated with the server or Host, a web server. In other embodiments, networking system 100 include additional, fewer, or different modules for various applications. Conventional components such as network interfaces, security functions, load balancers, failover servers, management and network operations consoles, and the like are not shown for better explanation of the details of the system.

Web hosting provider 180 refers to the universe of hosting services, e.g., smaller hosting services, larger hosting services and host management.

Saas (Software as a service), PaaS (Platform as a service) or IaaS (Infrastructure as a service) provider 190 refers to cloud services, hosting and the like.

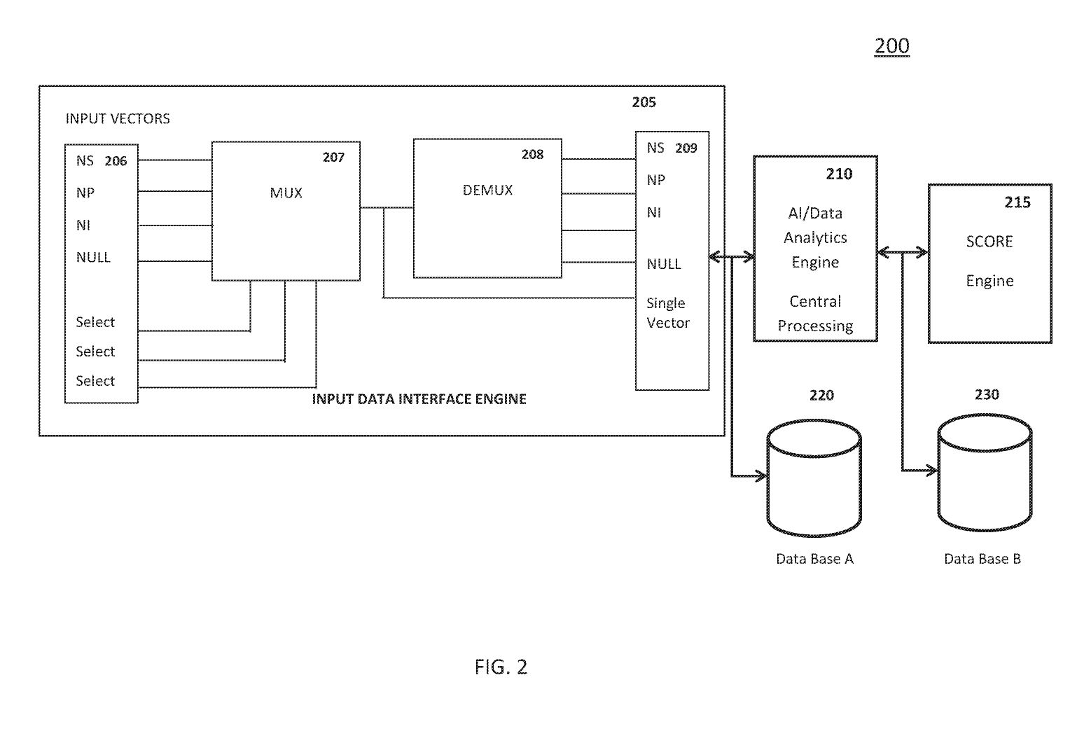

FIG. 2 depicts a high-level block diagram of a computing architecture benefiting from embodiments of the present invention. In one embodiment, computing architecture 200 comprises an input data interface 205, which is used for initial intake and interaction with the different users, Artificial Intelligence (AI)/Data Analytics Engine and Central Processing Engine 210 and SCORE Engine 215. In one embodiment, input data interface 205 is used in a manual mode of operation. In other embodiment, input data interface 205 is used in the automatic mode of operation. The automatic mode of operation comprises sub-modes namely, conventional score computation, synthesis of input vectors and simulation of input vectors.

In the conventional score computation mode, a score is computed using known vectors as further described below. In the synthesis of input vectors mode of operation, the Artificial Intelligence (AI) is used to synthesized various vectors based on commands provided by the user. In the simulation of input vectors mode of operation, the synthesized vectors are used to simulate input vectors to calculate a score.

In yet other embodiments, Input Data Interface Engine is used in the Manual or Test mode of operation.

Input Data Interface Engine 205 further comprises input vectors intake 206, Mux 207, Demux 208 and output Data Block 209, Data Base “A” 220 and Data Base “B” 230.

Mux 207 is used to select one input vector at a time whereas Demux 208 is used to select all the input vectors. Data Block 209 is a bi-directional line, functioning as an I/O apparatus. Data Base “A” 220 and Data Base “B” 230 are used to store data, for example data associated with users and hackers such as demographics, birthday, gender, school attended, interaction data, content associated with users and hackers such as messages, queued messages (e.g., email), text and SMS (short message service) messages, comment messages, messages sent using any suitable messaging technique, an HTTP link, HTML files, images, videos, audio clips, documents, document edits, calendar entries, events and other related files. Content items may be anything a user may upload, edit or interact with. In one embodiment, only one database is used. In other embodiments, multiple data bases are used.

In one embodiment, three (3) sets of variables to determine the vulnerability of an enterprise are defined as follows:
A) What kind of hackers may try to break into the enterprise corporate systems and data store;
B) What kind of initial IT data a hacker may have about the enterprise; and
C) How deep will the hacker get into an enterprise's computer environment?

As to the kind of hackers, five kinds are considered in MESERI:
Novice hacker/teenagers;
Average knowledge hacker;
White hat/Black hat hacker;
Determined adversary; and
A so-called “3-letter government agency” or foreign government.

As to the kind of initial IT data a hacker may have about the enterprise, four (4) kinds of initial data sets are considered in MESERI:
None what-so-ever;
One or a handful of user credentials (your users);
Actual (administrative) access to one of your network elements (e.g., router, switch, etc.); and
A trove of data, say a lost PC (physically or logically) from one of your users.

As to how deep will the hacker get into an enterprise's computer environment, six (6) types of devices are considered in MESERI:
Website (defacing, Denial of Service [DOS]);
Cloud services access (SaaS);
One enterprise PC or Virtual LANs (VLANs) or a set of wireless devices;
Multiple VLANs or major intranet portions;
Application access or Cloud services (PaaS, IaaS); and
Database access (firm's data, customer's data).

Clearly, if a novice hacker, with no prior IT data related to a given firm can get deep into the firm's network (say to an application or database) just for the trying, then said firm has a severe risk.

In other embodiments, those parameters are synthesized based on user command and simulated to produce a score. In yet other embodiments, a those parameters are synthesized based on user command and use a modeling tool.

In order to assess enterprises' security risk a measure is sought that is simple to use and provides a realistic and intuitive metric of the actual risk, which:
a) is a single scaler that ranges between to established points along a numerical continuum, for example 0 to 2000;
b) Increases (monotonically) as the risk increases;
c) Can be utilized to uniformly compare two (or more) firms.

In one embodiment, the comparison is done in terms of risk. In other embodiments, the comparison is done between one or more possible remediation strategies. For example, the Chief Executive Officer (CEO), Chief Risk Officer (CRO), Board, or the Investors may require that each company publish its score. A security certification agency acting as a testing firm could establish the score for the organization. Or, it can be estimated by the Chief Information Security Officer (CISO) prior to an infraction by empirically postulating some basic scenarios.

In other embodiments, a color-coding scheme can be used to describe the enterprise risk/predicament (and the MESERI index):

Purple=Super vulnerable; (very high risk);

Red=Very vulnerable (high risk);

Gold=Vulnerable (medium risk);

Yellow=Reasonably secure (reasonable risk);

Green=Secure (low risk); and

Azure=Very secure (very low risk).

In various embodiments, different schemes are used to communicate the degree of risk associated with an enterprise's computer system; however, those skilled in the art and informed by the teachings herein will realize that the various embodiments are also applicable to these different schemes.

In one embodiment, the above described parametric dimensions comprise: (1) NS=Normalized skill of hacker;

| Coordinate | |
|---|---|
| value | Coordinate point |
| 1.00 | Novice hacker/teenagers |
| 3.25 | Average knowledge hacker |
| 5.50 | White hat/Black hat hacker |
| 7.75 | Determined adversary |
| 10.00 | A so-called “3-letter government |
| | agency” or foreign government |

(2) NP=Normalized penetration of the enterprise by the hacker (targeted technical assets depth—this is ‘how deep’ the hacking agent can get);

| Coordinate | |
|---|---|
| value | Coordinate point |
| 1.00 | Website (defacing, DoS) |
| 2.60 | Cloud services access (SaaS) |
| 4.60 | One enterprise PC or VLAN or a |
| | set of wireless devices |
| 6.40 | Multiple VLANs or major intranet |
| | portions |
| 3.20 | Application access or Cloud |
| | services (PaaS, IaaS) |
| 10.00 | Database access (firm's data, |
| | customer's data) |

(3) NI=Normalized IT information available to the hacker (these parameters are also known as vectors).

| Coordinate | |
|---|---|
| value | Coordinate point |
| 1.00 | None what-so-ever |
| 4.00 | One or a handful of user |
| | credentials (your users) |
| 7.00 | Actual (administrative) access to |
| | one of your network elements |
| | (e.g., router, switch, etc.) |
| 10.00 | A trove of data, say a lost PC |
| | (physically or logically) from a |
| | member of the enterprise, with |
| | abundant content |

The value of MESERI will range from 0.63 to 2000. Furthermore, this method defines the following ranges:
0≦MESERI≦9 the risk is “Reasonably Low Risk” (yellow status);
10≦MESERI≦74 the risk is “Medium Risk” (gold status;
75≦MESERI≦399 the risk is “High Risk” (red status)
400≦MESERI≦2000 the risk is “Very High Risk” (purple status.

In other embodiments, these parameters are synthesized from user's input commands using the natural language analysis of AI Engine 210.

In other embodiments, these parameters are static as defined by the user or tester.

MESERI is then defined by the formula:

$$MESERI = \frac{( 11 - NS ) \times {NP}^{2}}{0.5 \sqrt{NI}}$$

The higher the MESERI index, the higher the risk. Notice generally that if the hacker skill is low, the index is higher than if the hacker skill is high. Also, as the penetration increases the MESERI index increases quadratically, that is (‘quite a bit’). Finally, as the information (needed) increases, the index decreases.

These parameters are normalized numbers defined within the context of the heuristic/analytical MESERI method. Thus, the MESERI score has specific weights assigned akin to FICO, DJIA, and the like, (all have internal weights).

A companion measure, the Enterprise Cybersecurity Confidence (ECCO) Index is also defined.

ECCO=max((2000−MISERI)/2−150,0)

ECCO ranges from 0 to 850 and it has the intuitive appeal of the FICO score in measuring the security environment

846≦ECCO Index≦850

Good Security Environment (green status)

813≦ECCO Index≦845

Reasonably Good Security Environment (light green status)

651≦ECCO Index≦812

Fair Security Environment (yellow status)

0≦ECCO Index≦650

Poor Security Environment (red status)

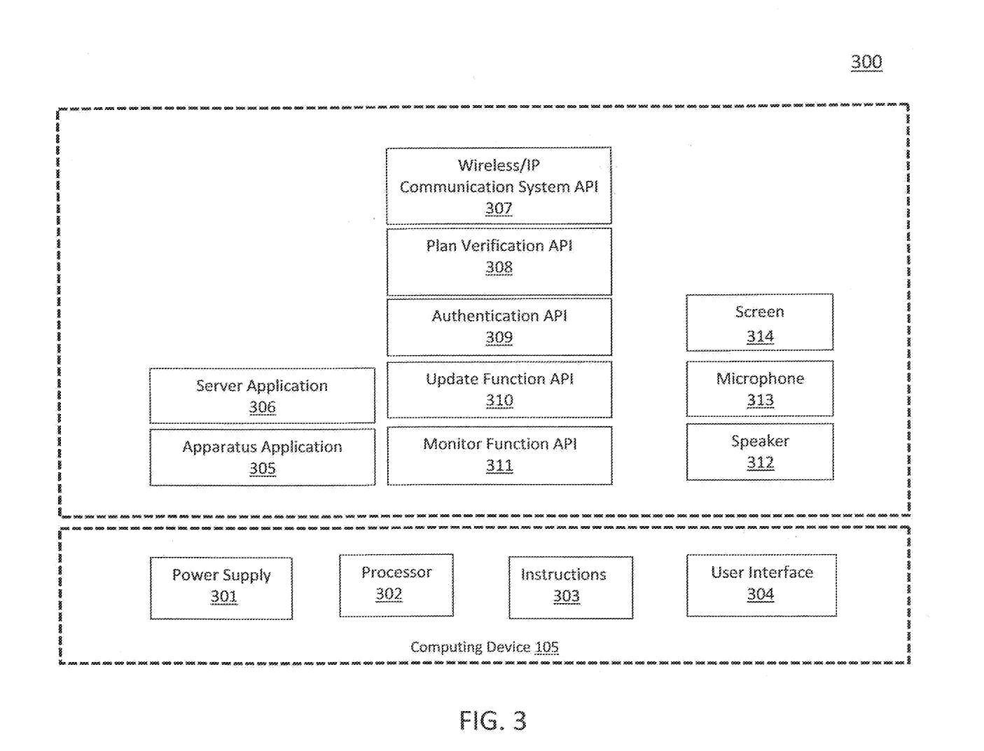

FIG. 3 depicts an exemplary computing device suitable for use in the architecture depicted in FIG. 2. Computing device 105 may include power supplies 301, a processor 302, and a memory 303 for storing instructions and the like, a user interface 304. Power supply 301 provides power to computing device 105. As such, the power supply may include, for example backup batteries. Other power supply configurations are possible as well. Processor 302 included in computing devices 105 may comprise one or more general-purpose processors and/or one or more special-purpose processors (e.g., image processor, digital signal processor, vector processor, etc.). To the extent that computing device 105 includes more than one processor, such processors could work separately or in combination. Computing device 105 may be configured to control functions of system 100 based on input received from one or more clients via user interface 304, for example.

Memory 303 may comprise one or more volatile and/or nonvolatile storage components such as optical, magnetic, and/or organic storage and memory 303 may be integrated in whole or in part with computing device 105. Memory 303 may contain instructions (e.g., applications programming interface, configuration data) executed by processor 302 in performing various functions of system 100, including any of the functions or methods described herein. Memory 303 may further include instructions executable by processor 302 to control and/or communicate with the additional components.

Peripherals may include speaker 314, microphone 313 and screen 316. Speaker 314 may be configured to output audio to the user of system 100. Similarly microphone 315 may be configured to receive audio from a user of system 100. Screen 316 may comprise one or more devices used for displaying information to the user of computing device 105. Screen 316 may comprise a touchscreen used by a user to input commands to computing device 105. As such, a touchscreen may be configured to sense at least one of a position in the movement of a user's finger via capacitive sensing, or a surface acoustic wave process among other possibilities. Generally, a touchscreen may be capable of sensing finger movement in a direction parallel or perpendicular to the touchscreen surface of both, and may also be capable of sensing a level of pressure applied to the touchscreen surface. A touchscreen comes in different shapes and forms.

Computing device 105 may include one or more elements in addition to or instead of those shown.

System 200 is developed mainly on two platforms namely, apparatus application 305 and server application 306. Apparatus application 305 is developed using JAVA and Eclipse as SDK (Software Development Kit). Server application 306 is developed using PHP language and MySQL as data base. Languages equivalent to JAVA and Eclipse, PHP and MySQL may be used to build Apparatus application 305 and Server application 306. Various APIs (307, 308 309, 310, and 311) are used for the various functions of system 200.

These APIs are also used in various embodiments for transferring data from Server application 306 to Apparatus application 305. Although depicted and described with respect to the aforementioned APIs, it will be appreciated by those skilled in the art that other APIs having similar functionality are considered to be within the scope of the present embodiments.

In one embodiment, APIs (308, 309, and 310) are used for passing Email and password parameters from Apparatus application 305 to Server application 306 and used to validate the login of the user.

In one embodiment, APIs (307, 308, 309, and 310) transfer Email parameters from Apparatus application 305 to Server application 306 and new password is sent to users email.

Generally speaking, apparatus 105 include any Internet enabled device such as personal digital assistant (PDA), laptop, desktop, electronic book, tablets and the like capable of accessing the Internet may implement the various embodiments described herein. While apparatus 105 is generally discussed within the context of the description, the use of any device having similar functionality is considered to be within the scope of the present embodiments.

Although depicted and described with respect to an embodiment in which each of the APIs, engines, databases, and tools is stored within memory 303, it will be appreciated by those skilled in the art that the APIs, engines, database, and/or tools may be stored in one or more other storage devices internal to computing device 105.

The APIs, engines and tools may be activated in any suitable manner. In one embodiment, for example, the APIs, engines and tools may be activated in response to manual requests initiated by a user, in response to automated requests initiated by computing device 105, or other devices and the like, as well as various combinations thereof. For example, where an engine or tool is activated automatically, the engine or tool may be activated in response to scheduled requests, in response to requests initiated by computing device 105 based on processing performed at computing device 105.

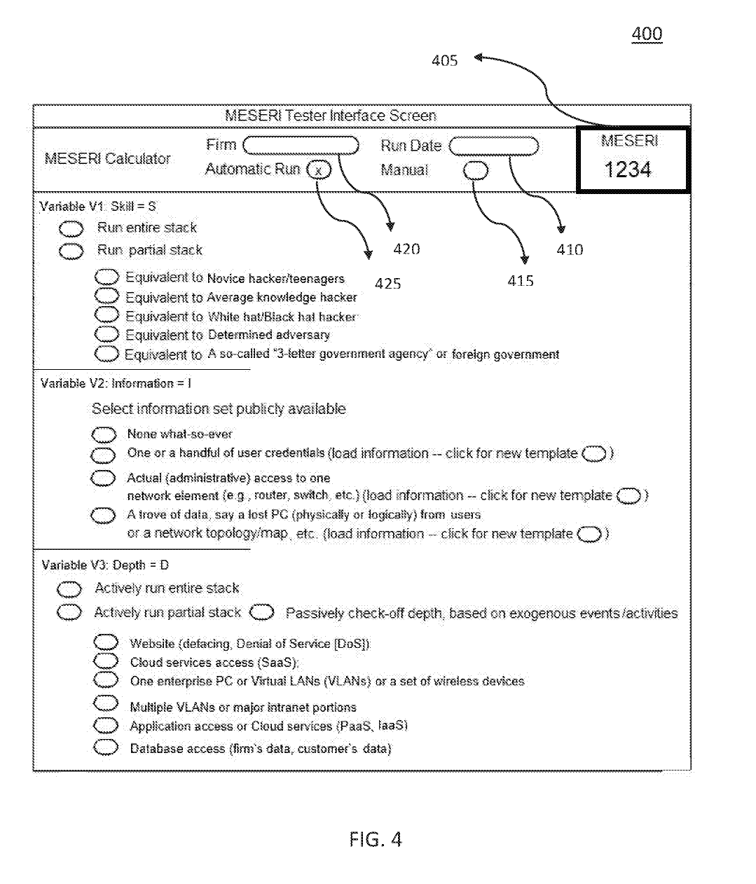

FIG. 4 depicts an exemplary user screen interface suitable for use in the system depicted in FIG. 2. For example, a user interacts with user interface 400 to place the system in a specific operational mode. In one embodiment, automatic operational mode 415 is selected and manual operational mode 420 is off. The user also verifies various parameters, such as MESERI or Score 405, Date of the operation 410 and the entity's name 420.

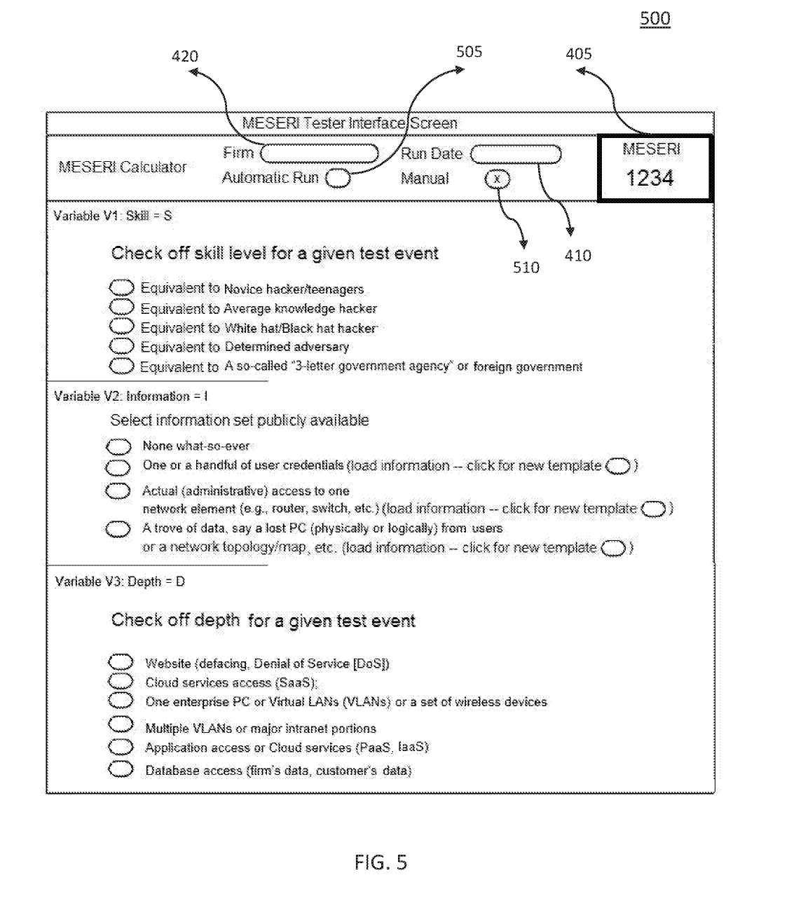

FIG. 5 depicts an exemplary user screen interface suitable for use in the system depicted in FIG. 2. In this embodiment, automatic operation mode 505 is off and manual operation mode 510 is selected. The user also verifies various parameters, such as MESERI or Score 405, Date of the operation 410 and the entity's name 420 and other parameters associated with the specific mode of operation.

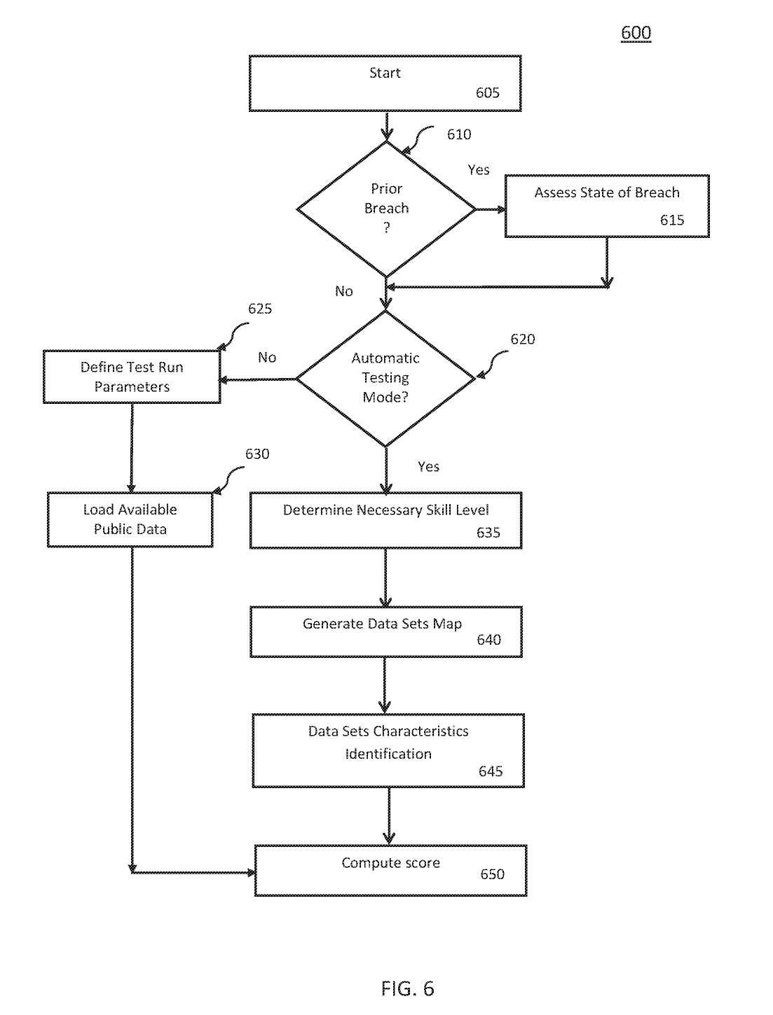

FIG. 6 depicts a Flow Chart of a process for implementing the algorithm according to an embodiment of the invention.

Various embodiments operate to provide a system and method for uniform measure and assessment of an institution's aggregate a cyber security risk and of the institution's cybersecurity confidence index. Moreover, the present embodiments enable a user to simulate and/or test the different vectors associated with computing a one-dimensional cybersecurity score.

At step 605, a user accesses the system; the user is identified and authenticated.

At step 610, the prior breach function is executed. The user is queried to ascertain if the system was ever subject to a prior breach. If yes, the assess state of breach is executed; otherwise step 620 is executed.

At step 615, the state of the breach function is executed. As articulated above, there are three (3) broad states of the breach namely, Human errors, System glitches and Malicious or criminal attacks. In other embodiments, other states are considered for example, a hybrid-state such robot-human state.

At step 620, the mode of operation is determined. The user is queried to ascertain which mode of operation to run. If yes, the automatic mode is executed; otherwise step 625 is executed.

At step 635, the necessary skill level is determined.

The automatic mode of operation comprises sub-modes namely, conventional score computation, synthesis of input vectors and simulation of input vectors.

In the conventional score computation mode, a score is computed using known vectors as described above. In the synthesis of input vectors mode of operation, the Artificial Intelligence (AI) is used to synthesized various vectors based on commands provided by the user. In the simulation of input vectors mode of operation, the synthesized vectors are used to simulate input vectors to calculate a score.

At step 640, a map of data sets including technical and non-technical assets for an entity is generated, for example web site, data bases, devices such as routers, firewalls, domain names, IP address and the like. In some embodiments, semi-automated process allows mapping of data entity attributes for a greater number of entities in a shorter period of time than a completely manual analysis process.

At step 645, data sets characteristics are identified. For example, the characteristics could indicate if a single Internet Protocol address is associated with multiple domain names. In some embodiments, the characteristics could indicate if a single server or group of servers host multiple web sites when multiple domain names were associated with single Internet Protocol address.

At step 650, MISERI or score is computed. The result is displayed as shown in user interfaces 400 and 500.

As described above, when the user selects manual mode, step 625 is executed. The manual test mode allows a tester (human or also mechanized) to define test run parameters. In the preferred embodiment, any combination of NS, NI, ND can be tested, on the assumption that the environment admits multiple values of these variables: in some cases, a given ND value may in theory be missing—for example, an institution may not have a cloud-based service, hence the case NP2: Cloud services access (SaaS), or NP5: Application access or Cloud services (PaaS, IaaS) are not testable; also, there may or may not be multiple scenarios (available) for NI.

The parametric weights (“coordinate values”) used in conjunction with NS, NP, NI are arbitrary, but have been uniquely chosen (1) to keep the measure in a defined range (0, 2000); (2) to ascertain that the resulting metric under various (all) the use cases follow what would be an intuitive expectation of the observer, e.g., as the penetration goes deeper, the risk is higher; as the needed skill of the person/entity/system endeavoring to breach the system increases, the risk of the firm would decrease; as the (utilized) static/pre-breach information about the firm needed/used by the person/entity/system endeavoring to breach the system increases, the risk of the firm would decrease; and (3) also to ascertain certain “smoothness” of the metric (although by definition this matric is discrete and not continuous. The canonical value for the “coordinate values” chosen herewith represents the baseline embodiment.

In the preferred embodiment, a unique pair of values (NS, NP), for a statically-defined (given) NI is utilized to compute MESERI. In other embodiments, e.g., when a computer system is used, the MESERI value is computed for multiple (even all thirty pairs, if possible) combinations of NS/NP and the lowest value of the various MESERI calculation is used as the final MESERI measure (Score).

In some embodiments the number of pairs of combinations for NS/NP is larger than 30 (based on the variable set {V}).

At step 630, any publicly available data is loaded. In some embodiments, the data is pushed (manual input) onto the system. In other embodiments, the data is pulled (downloaded) onto the system.

At step 650, MISERI or score is computed. The result is displayed as shown in user interfaces 400 and 500.

Although primarily depicted and described herein with respect to the embodiments described herein, it will be appreciated that the algorithm may be used in other embodiments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the sub-stance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore 65 intended that the scope of the invention be limited not by this detailed description, but rather by any claims that issue on an application based hereon.

Although various embodiments which incorporate the teachings of the present invention have been shown and described in detail herein, those skilled in the art can readily devise many other varied embodiments that still incorporate these teachings

We claim:

1. A method comprising:
(a) determining a skill level necessary to compromise the integrity of technical assets associated with security characteristics of a computer system;
(b) generating a map of data sets associated with the corresponding technical assets;
(c) identifying the characteristics of the data sets and availability of data associated with respective technical assets;
(d) determining a state of breach associated with a security event; and
(e) computing a one-dimensional cybersecurity score,
wherein the technical assets comprise information associated with the computer system.

2. The method of claim 1, wherein the skill level comprises
one of: novice hacker or teenager, average knowledge hacker, white hat/Black hat hacker, determined adversary and 3-letter government agency.

3. The method of claim 1, further comprising:
compiling one or more databases associated with the map of the characteristics of the data sets of the computer system, said characteristics include location coordinates, nodes, security policies, audit logs, cookies, users, make, model, type, history of said computer system; and
updating one or more corresponding databases associated with respective computer system.

4. The method of claim 3, further comprising assessing the state of a breach prior to performing steps (a)-(e) when the historical data includes a previous breach.

5. The method of claim 1, wherein the data sets comprise network related information including network architecture,
network element, network infrastructure.

6. The method of claim 1, wherein availability of data comprise no information about the technical assets, one user credential, a handful of user credentials, actual administrative access to or more of network elements, a trove of data.

7. The method of claim 1, wherein the one-dimensional cybersecurity score is obtained by computing the Equation:
$$SCORE = \frac{( 11 - NS ) \times {NP}^{2}}{( 0.5 ) {( NI )}^{1 / 2}}$$
where:
NS is the normalized skill of an intruder;
NP is the normalized state or penetration of the breach;
NI is the normalized data sets associated with the technical assets.

8. The method of claim 1, wherein the state of the breach comprises human error breach, system glitch breach and malicious breach.

9. The method of claim 1, comprising an automatic mode of operation.

10. The method of claim 9, wherein the automatic mode of operation uses Artificial Intelligence (AI) to simulate one or more vectors.

11. The method of claim 1, comprising a manual mode of operation.

12. The method of claim 1, wherein the Enterprise Cybersecurity Confidence (ECCO) index is obtained by computing the Equation:
ECCO=max((2000−SCORE)/2−150,0).

13. A system comprising:
a computing architecture having an input data interface engine communicatively coupled to a data analytics engine, a score engine, a central processing engine, one or more databases, said computing architecture configured to determine a common and uniform measure of aggregate cybersecurity risk; and
a non-transitory computer readable medium having stored
thereon instructions that, upon execution by the central processing engine, cause the central processing engine to execute one or more applications associated with defining a one-dimensional cybersecurity score thereby enabling the exchange of a plurality of data points for use in computing the one-dimensional cybersecurity score and updating the one or more corresponding applications,
wherein the one-dimensional cybersecurity score is used to measure the robustness of a computer system architecture to security threats and breaches.

14. The system of claim 13, wherein the computing architecture comprises a server or host communicatively coupled to
the cloud, said server propagates configuration data towards
the central processing unit, thereby enabling said at least
central processing unit to interact with the plurality of engines to exchange a plurality of data points with at least
engine for use in computing the one-dimensional cybersecurity score.

15. The system of claim 14, wherein the cloud comprises a social network, a virtual private network (VPN), a wide area network (WAN), a local area network (LAN), corporate LAN, the Internet, satellite communication network, cellular network.

16. The system of claim 13, wherein the central processing unit further comprises:
a non-transitory computer readable medium having stored thereon instructions that, upon execution by the central processing unit, cause the central processing unit to
perform a method comprising:
determining a skill level necessary to compromise the integrity of technical assets associated with security characteristics of a computer system;
generating a map of data sets associated with the corresponding technical assets;
identifying the characteristics of the data sets and availability of data associated with respective technical assets;
determining a state of breach associated with a security event; and
computing a one-dimensional cybersecurity score,
wherein the technical assets comprise information associated with the computer system.
